(19) United States
(12) Patent Application Publication
(10) Pub. No.: US 2025/0258600 A1
(43) Pub. Date: Aug. 14, 2025

(54) LOSSY COMPRESSION IN MEMORY

(71) Applicant: Micron Technology, Inc., Boise, ID (US)

(72) Inventor: Emanuele CONFALONIERI, Segrate (IT)

(21) Appl. No.: 19/012,074

(22) Filed: Jan. 7, 2025

Related U.S. Application Data
(60) Provisional application No. 63/551,778, filed on Feb. 9, 2024.

(51) Int. Cl. G06F 3/06

(52) U.S. Cl. CPC G06F 3/0608; G06F 3/0644; G06F 3/0673

(57) ABSTRACT

In some implementations, a controller may receive and from a host device, a command to write data to a memory location. The controller may compress the data using a lossy compression operation to obtain compressed data. The controller may cause the compressed data to be written to the memory location.

### CROSS-REFERENCE TO RELATED APPLICATION

This Patent Application claims priority to U.S. Provisional Patent Application No. 63/551,778, filed on Feb. 9, 2024, and entitled “LOSSY COMPRESSION IN MEMORY.” The disclosure of the prior Application is considered part of and is incorporated by reference into this Patent Application.

### TECHNICAL FIELD

The present disclosure generally relates to memory devices, memory device operations, and, for example, to lossy compression in memory.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system capable of lossy compression in memory.

FIG. 2 is a diagram illustrating an example system capable of lossy compression in memory.

FIG. 3 is a diagram illustrating an example CXL fabric configuration capable of lossy compression in memory.

FIGS. 4A-4C are diagrams of an example of lossy compression in memory.

FIG. 5 is a diagram of an example of a controller.

FIG. 6 is a diagram of an example system with memory pooling.

FIG. 7 is a flowchart of an example method associated with lossy compression in memory.

### DETAILED DESCRIPTION

Emerging computing applications, such as artificial intelligence, cloud computing, or virtual reality, may involve the use of very large datasets. The efficient processing of large datasets requires a significant amount of memory (e.g., random-access memory (RAM)). In some cases, virtual memory, which uses storage (e.g., disk storage) to provide a virtual address space that can exceed a capacity of main memory, is one technique to accommodate large datasets. However, virtual memory may be associated with diminished system performance. Furthermore, expanding a system's main memory may be cost prohibitive.

Compression enables data size to be reduced, thereby increasing memory capacity, lowering energy costs, and reducing bandwidth consumption. For example, compression may alleviate memory bandwidth pressure by reducing a volume of data transferred between a main memory and a processor. In general, main memory compression is performed at a system level (e.g., by a host system). Moreover, main memory compression generally employs lossless compression methods, which are not associated with high compression ratios.

Some implementations described herein exploit memory disaggregation to enable data compression to be performed by a memory system (e.g., a CXL memory module), rather than compression being performed at a host processor. This enables a relatively smaller amount of memory to provide increased memory capacity. In some implementations, the compression performed by the memory system may be a lossy compression (e.g., used in approximated computing), which can be utilized with large classes of applications that are tolerant to approximation. For example, the memory system may include a lossy compression and decompression engine. “Lossy compression” refers to a data compression technique that reduces the data size of content by selectively and permanently discarding portions of the original data of the content.

At a system level, one or more memory systems enabled with lossy compression may be part of a memory pool (e.g., along with one or more memory systems that are not enabled with lossy compression). In some implementations, a host system may flag pages allocated for an application as being approximable or not approximable in accordance with a configuration for the application that indicates whether particular data regions are approximable. “Approximable” information can be adequately represented or approximated with an acceptable degree of precision, enabling the removal of less-significant details to achieve compression. A memory system enabled with lossy compression may be used to compress and store approximable pages, thereby efficiently utilizing resources of the memory pool. In this way, large amounts of data can be managed in memory without the use of storage (e.g., disk storage), thereby improving system performance. Furthermore, the high compression ratios associated with lossy compression enable increased memory capacity in a relatively smaller amount of memory. Accordingly, due to the flexibility of disaggregated systems, these high-capacity memory resources can be made available to a rack or a fabric and may be used to address the needs of applications that are tolerant to approximation.

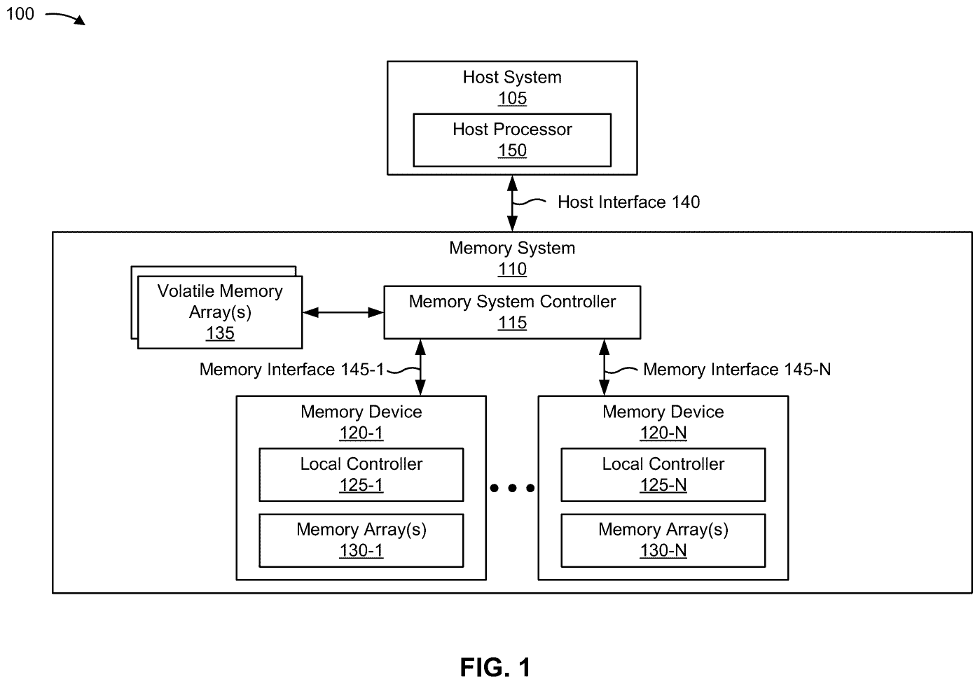

FIG. 1 is a diagram illustrating an example system 100 capable of lossy compression in memory. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a RAM device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

In some examples, the memory device 120 may be a compute express link (CXL) compliant memory device 120. For example, the memory device 120 may include a PCIe/CXL interface (e.g., the host interface 140 may be associated with a PCIe/CXL interface). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide advanced protocol in areas such as input/output (I/O) protocol, memory protocol, and coherency interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

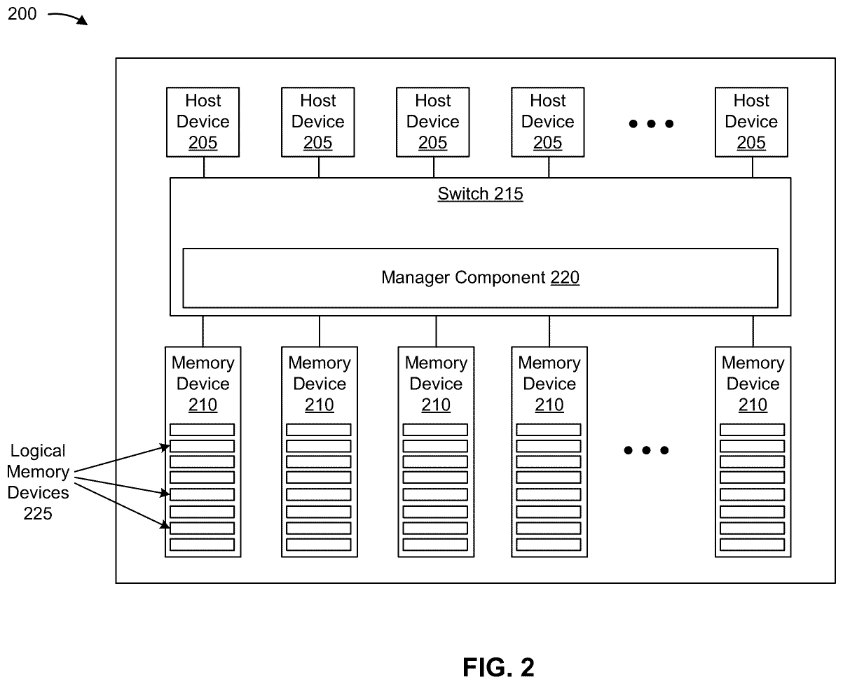

FIG. 2 is a diagram illustrating an example system 200 capable of lossy compression in memory. The system 200 may include one or more devices, apparatuses, and/or components for performing operations described herein. In some implementations, the system 200 is a CXL system. For example, the system 200 may be configured to utilize memory pooling with multiple logical devices.

As shown, the system 200 may include a plurality of host devices 205 and a plurality of memory devices 210. The host devices 205 may include CPUs. In some implementations, each host device 205 corresponds to the host system 105 and/or the host processor 150. The memory devices 210 may include CXL devices (e.g., CXL compliant devices). In some implementations, the memory devices 210 may include Type 3 CXL devices. For example, the memory devices 210 may include memory modules and/or memory expansion devices (e.g., volatile memory devices). As an example, a memory device 210 may include a memory controller (e.g., a CXL ASIC controller) and one or more memory components (e.g., memory packages) coupled to the memory controller. In some implementations, each memory device 210 may correspond to a memory system 110 or a memory device 120.

The host devices 205 and the memory devices 210 may be communicatively coupled via a switch 215 (e.g., one or more switches 215). In some implementations, the switch 215 is a CXL switch. The switch 215 may include a hardware bridge, such as a PCIe bridge. In some implementations, the system 200 (e.g., the host devices 205, the memory devices 210, and/or the switch 215) may be in a fabric configuration. For example, the system 200 (e.g., the host devices 205, the memory devices 210, and/or the switch 215) may be in a configuration of a CXL fabric.

The system 200 may include a manager component 220. The manager component 220 may be a device or implemented in a device. For example, the manager component 220 is shown as a component of the switch 215, but may reside outside of the switch 215 in some examples. The manager component 220 may be configured to manage the fabric of the system 200 (e.g., the manager component 220 may be a fabric manager). The manager component 220 may be implemented in hardware and/or software.

The memory devices 210 may form a memory pool for the host devices 205. In some implementations, the memory (e.g., the memory components) of a memory device 210 may be mapped to one or more (e.g., multiple) logical memory devices 225. At a system level, a logical memory device 225 may correspond to a range of memory addresses. The logical memory devices 225 of a memory device 210 may be available to one or more of the host devices 205. For example, all of the logical memory devices 225 of a single memory device 210 may be available to a particular host device 205, or a subset of the logical memory devices 225 of a single memory device 210 may be available to a particular host device 205. In some implementations, the logical memory devices 225 available to a particular host device 205 may be distributed across multiple memory devices 210.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

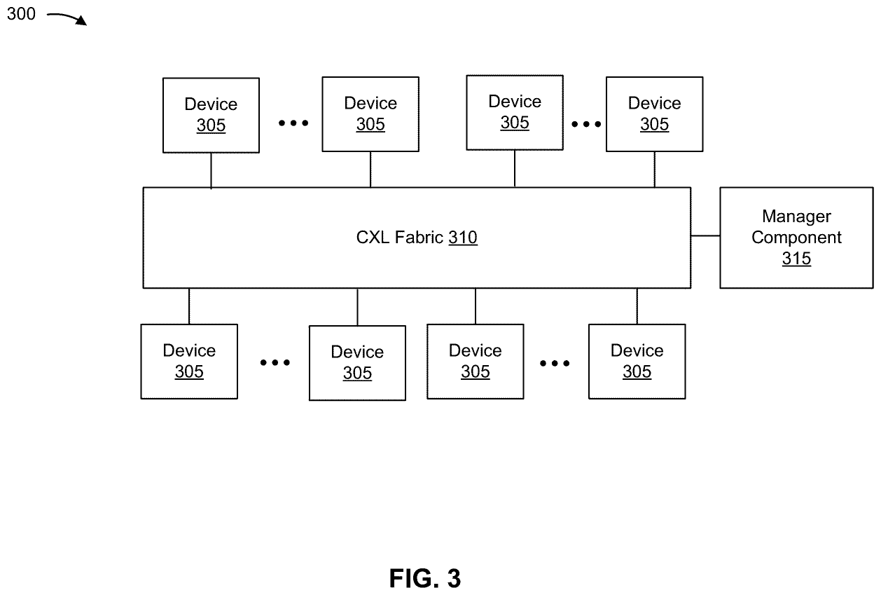

FIG. 3 is a diagram illustrating an example CXL fabric configuration 300 capable of lossy compression in memory. As shown, a plurality of devices 305 (e.g., CXL compliant devices) may be interconnected via the CXL fabric 310. The plurality of devices 305 may include one or more host devices (e.g., host devices 205), one or more Type 1 CXL devices (e.g., specialized accelerators, such as network interface controllers), one or more Type 2 CXL devices (e.g., general-purpose accelerators, such as GPUs, ASICs, or FPGAs), and/or one or more Type 3 CXL devices (e.g., global fabric attached memory (GFAM) devices, such as memory devices 210). The CXL fabric 310 may be configured to interconnect the devices 305 to enable communication (e.g., peer-to-peer communication) between the devices 305. The CXL fabric may be implemented in hardware and/or software. As further shown, the CXL fabric configuration 300 may include a manager component 315, similar to the manager component 220 described herein.

In some implementations, one or more systems, devices, apparatuses, components, and/or controllers of FIGS. 1-3 may be configured to receive, from a host device, a command to write data to a memory location; compress the data to obtain compressed data, responsive to the memory location corresponding to a logical memory device that is configured with lossy compression enabled; and cause the compressed data to be written to the memory location.

In some implementations, one or more systems, devices, apparatuses, components, and/or controllers of FIGS. 1-3 may be configured to receive, from a host device, a command to write data to a memory location; compress the data using a lossy compression operation to obtain compressed data, responsive to the memory location corresponding to a logical memory device that is configured with lossy compression enabled; and write the compressed data to the memory location.

In some implementations, one or more systems, devices, apparatuses, components, and/or controllers of FIGS. 1-3 may be configured to receive, from a host device, a command to write data to a memory location; compress the data using a lossy compression operation to obtain compressed data; and cause the compressed data to be written to the memory location.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more operations described as being performed by another set of components shown in FIG. 3.

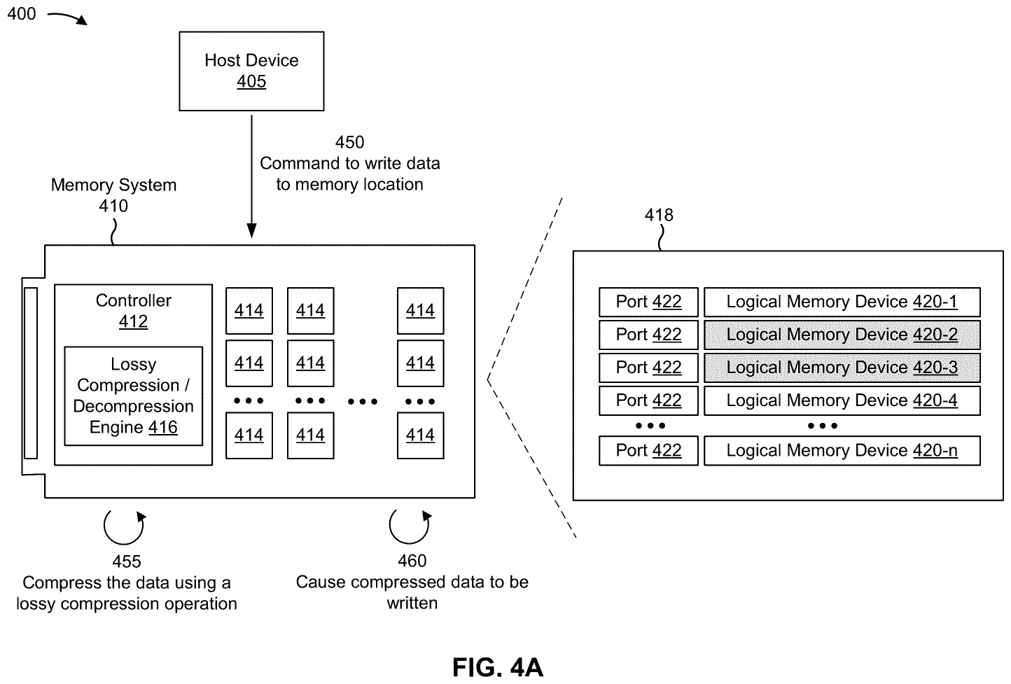

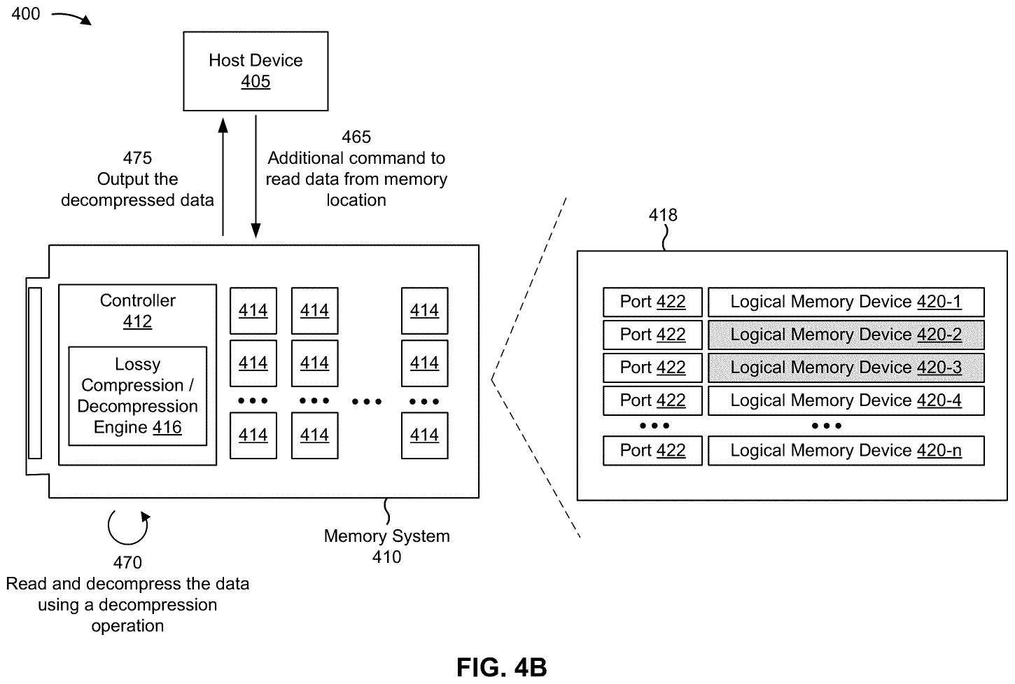

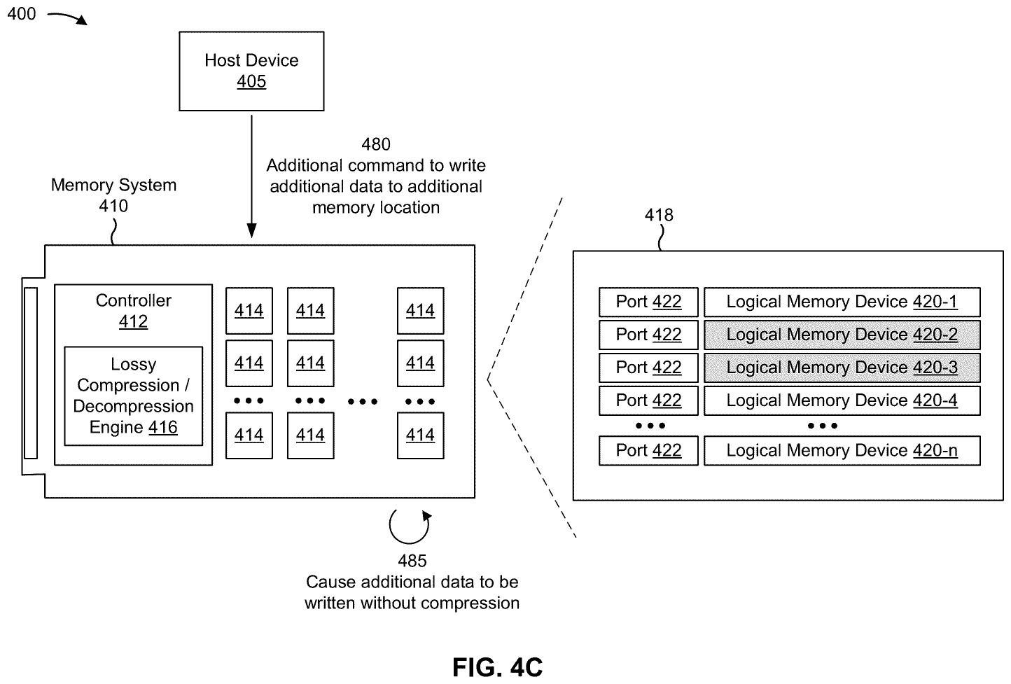

FIGS. 4A-4C are diagrams of an example 400 of lossy compression in memory. As shown, example 400 includes a host device 405 and a memory system 410. The host device 405 may correspond to the host system 105, the host processor 150, a host device 205, and/or a device 305. The memory system 410 may correspond to the memory system 110, a memory device 120, a memory device 210, and/or a device 305. For example, the host device 405 and the memory system 410 may be in the system 200 and/or in the CXL fabric configuration 300.

In some implementations, the memory system 410 is a Type 3 CXL device. For example, the memory system 410 may include a memory module and/or a memory expansion device. As shown, the memory system 410 includes a controller 412 and one or more memory components 414 (e.g., memory packages). The controller 412 may include an ASIC, an FPGA, or the like. In some implementations, the controller 412 may include a lossy compression/decompression engine 416. The lossy compression/decompression engine 416 enables the memory system 410 to compress data using a lossy compression operation. The lossy compression/decompression engine 416 may be implemented in hardware and/or software.

As shown, the memory system 410 may have a logical characterization 418. In the logical characterization 418 of the memory system 410, the memory components 414 may be configured as multiple logical memory devices 420, as described herein. In some implementations, one or more of the logical memory devices 420 may be configured with lossy compression enabled (e.g., logical memory devices 420-2 and 420-3 in example 400). Moreover, one or more of the logical memory devices 420 may be configured with lossy compression disabled (e.g., logical memory devices 420-1, 420-4, and 420-n in example 400). In other words, the memory system 410 is configurable such that lossy compression (e.g., the lossy compression/decompression engine 416) may be selectively enabled or disabled in each logical memory device 420 (e.g., enabled or disabled on a per-logical-memory-device basis). In some implementations, the memory components 414 may be configured as a single logical memory device 420 configured with lossy compression enabled or disabled. In some implementations, the logical memory devices 420 may be selectively configured with lossy compression enabled or disabled at an initialization (e.g., a booting) of the memory system 410.

As further shown, the logical characterization 418 may include one or more logical ports 422 (also referred to as “CXL ports” or “heads”) configured to handle requests to the logical memory devices 420. For example, the logical memory devices 420 may be mapped to the one or more logical ports 422. In some implementations, the logical characterization 418 may include multiple logical ports 422.

The host device 405 may implement one or more applications (e.g., artificial intelligence applications, graphics applications, or the like). Particular data regions of an application may be configured (e.g., annotated) as being approximable (e.g., by a programmer of the application, using a specialized system call). For example, in a graphics application, data relating to a background of an image may be configured as being approximable. In some implementations, approximable data may be configured with one or more error thresholds (e.g., by a programmer of the application). For example, a first threshold may limit an allowable error that is introduced by a single compression event, and a second threshold may limit a total accumulated error across the full application lifetime.

The host device 405 may allocate one or more pages for an application executing on the host device 405. The host device 405 may mark an allocated page as being approximable if the page is to contain application data configured as being approximable. For example, the host device 405 may flag pages as being approximable or not approximable. As an example, each entry for a page in a page table and/or a translation lookaside buffer (TLB) may include an approximable indication (e.g., an additional bit) to indicate whether the page is approximable.

If data to be written to memory is associated with a flag indicating that the data is approximable (e.g., in the page table and/or the TLB), then the host device 405 may map the data to a memory location (e.g., a memory address) associated with a logical memory device 420 configured with lossy compression enabled. For example, the host device 405 may store information indicating one or more address ranges associated with logical memory devices 420 configured with lossy compression enabled and/or indicating one or more address ranges associated with logical memory devices 420 configured with lossy compression disabled (or that are incapable of lossy compression). In this way, one or more logical memory devices 420 configured with lossy compression enabled can be used to store approximable pages.

As shown in FIG. 4A, and by reference number 450, the host device 405 may transmit, and the controller 412 may receive, a command to write the data to the memory location. The controller 412 may identify that the memory location corresponds to a logical memory device 420 that is configured with lossy compression enabled (e.g., logical memory device 420-2 or 420-3), which indicates that the data is to be compressed before being written.

As shown by reference number 455, responsive to the memory location corresponding to a logical memory device 420 that is configured with lossy compression enabled, the controller 412 may compress the data using a lossy compression operation to obtain compressed data. For example, the controller 412 may be configured to compress the data using the lossy compression/decompression engine 416. The lossy compression operation may reduce the size of the data. The lossy compression operation may use a lossy compression model or algorithm. For example, the lossy compression operation may use a fast, error-bounded, lossy high-performance computing (HPC) data compression, such as a Squeeze (SZ) algorithm, an SZx algorithm, or another algorithm.

As shown by reference number 460, the controller 412 may cause the compressed data to be written to the memory location (e.g., the controller 412 may write the compressed data to the memory location). For example, the controller 412 may cause the compressed data to be written to one or more memory components 414 mapped to the logical memory device 420. Writing the compressed data to memory, rather than the original uncompressed data, increases the virtual memory capacity of the memory system 410.

In some implementations, prior to writing the compressed data to the memory location, the controller 412 may determine an error value for the compressed data. To determine the error value, the controller 412 may decompress the compressed data to obtain decompressed data (e.g., using the lossy compression/decompression engine 416) and compare the decompressed data to the original data. For example, the error value may be in accordance with a difference between the decompressed data and the original data. Accordingly, the controller 412 may cause the compressed data to be written to the memory location responsive to the error value satisfying a threshold (e.g., the error value does not exceed the threshold). Otherwise, if the error value does not satisfy the threshold (e.g., the error value exceeds the threshold), the controller 412 may discard the compressed data and may cause the original uncompressed data to be written to the memory location (e.g., compression is skipped for the data).

In some implementations, the controller 412 may cause the compressed data to be written to the memory location if a relative error (e.g., computed as described above) of each individual value of a block does not exceed a first percentage threshold. Additionally, or alternatively, the controller 412 may cause the compressed data to be written to the memory location if the average relative error across all values of the block does not exceed a second percentage threshold.

In some implementations, the controller 412 may determine an updated virtual memory capacity of the logical memory devices 420 resulting from writing the compressed data to the memory location. For example, compressing the data may result in an increased virtual memory capacity. The controller 412 may output an indication of the updated virtual memory capacity to the host device 405. In some implementations, the memory system 410 may utilize a CXL dynamic capacity feature to manage capacity changes due to compression.

As shown in FIG. 4B, and by reference number 465, the host device 405 may transmit, and the controller 412 may receive an additional command to read from the memory location. The controller 412 may identify that the memory location corresponds to a logical memory device 420 that is configured with lossy compression enabled (e.g., logical memory device 420-2 or 420-3), which indicates that the data being read is to be decompressed.

As shown by reference number 470, responsive to the memory location corresponding to a logical memory device 420 that is configured with lossy compression enabled, the controller 412 may read the compressed data from the memory location and decompress the compressed data using a decompression operation to obtain decompressed data. For example, the controller 412 may be configured to decompress the data using the lossy compression/decompression engine 416. The decompression operation may correlate to the lossy compression operation (e.g., the decompression operation may provide decompression of data compressed by the lossy compression operation). As shown by reference number 475, the memory system 410 (e.g., the controller 412) may then output the decompressed data to the host device 405.

As shown in FIG. 4C, and by reference number 480, the host device 405 may transmit, and the controller 412 may receive an additional command to write additional data to an additional memory location. The controller 412 may identify that the additional memory location corresponds to a different logical memory device 420 that is configured with lossy compression disabled (e.g., logical memory device 420-1, 420-4, or 420-n), which indicates that the additional data is to be written uncompressed. Accordingly, as shown by reference number 485, responsive to the memory location corresponding to the different logical memory device 420 that is configured with lossy compression disabled, the controller 412 may cause the additional data to be written to the additional memory location without using the lossy compression operation (e.g., the controller 412 may write the additional data to the additional memory location without lossy compression). For example, the controller 412 may cause the additional data to be written, without lossy compression, to one or more memory components 414 mapped to the different logical memory device 420.

As indicated above, FIG. 4 is provided as an example. Other examples may differ from what is described with regard to FIG. 4.

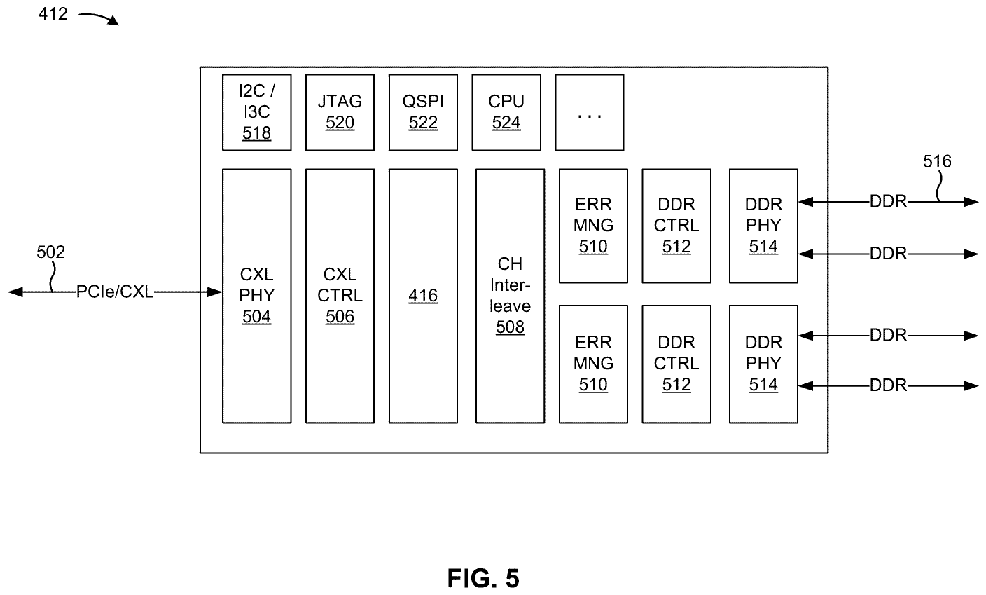

FIG. 5 is a diagram of an example of the controller 412. As shown, a PCIe/CXL interconnect 502 (e.g., based on the PCIe physical link layer and the CXL protocol) may connect to a CXL physical layer (PHY) component 504 of the controller 412. The controller 412 may include a CXL control component 506, the lossy compression/decompression engine 416, a channel interleaver component 508 (e.g., configured to remap an address to a physical memory address), one or more error manager components 510, one or more DDR control components 512, and/or one or more DDR PHY components 514. The DDR PHY components 514 may be configured to drive a memory bus interface via one or more DDR interconnects 516. The controller 412 may also include one or more peripherals, such as an inter-integrated circuit (I2C) and/or improved inter-integrated circuit (I3C) component 518, a Joint Test Action Group (JTAG) component 520, a quad serial peripheral interface (QSPI) component 522, and/or a CPU 524 (e.g., for peripheral computing operations, such as security operations), among other examples.

As indicated above, FIG. 5 is provided as an example. Other examples may differ from what is described with regard to FIG. 5.

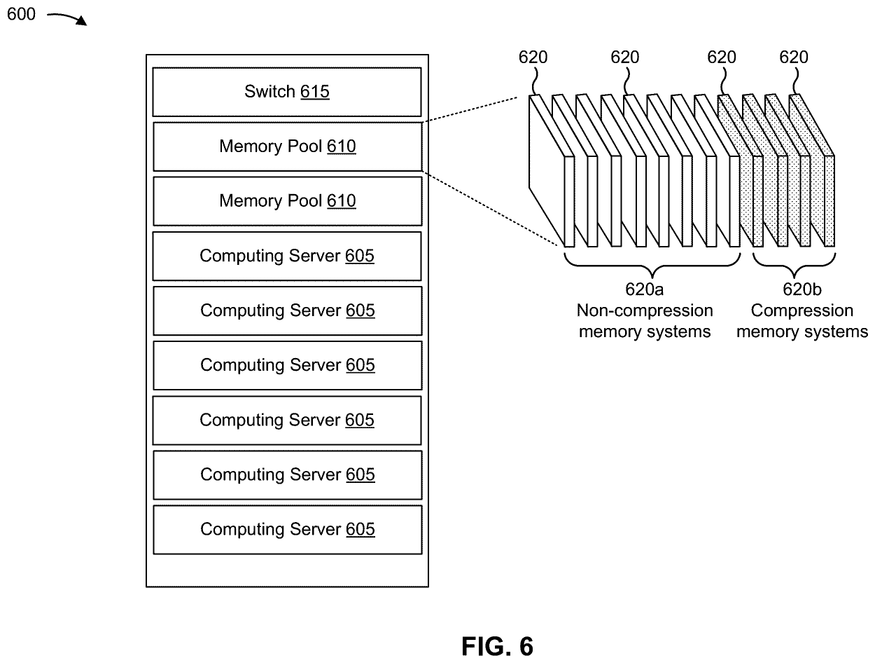

FIG. 6 is a diagram of an example system 600 with memory pooling. The system 600 is illustrated as a rack system, but other configurations for the system 600 may be employed. As shown, the system 600 may include one or more computing servers 605 (e.g., each corresponding to a host device 405 or collectively corresponding to a host device 405), a memory pool 610, and a switch 615 (e.g., a top-of-rack (TOR) switch, which may correspond to switch 215).

The memory pool 610 may include a plurality of memory systems 620. The memory systems 620 may be Type 3 CXL devices. For example, the memory systems 620 may include memory modules and/or memory expansion devices. The memory systems 620 may include one or more non-compression memory systems 620a and/or one or more compression memory systems 620b. A non-compression memory system 620a may lack a capability to perform lossy compression. For example, a non-compression memory system 620a may lack a lossy compression/decompression engine, as described herein. A compression memory system 620b may have a capability to perform lossy compression. For example, a compression memory system 620b may correspond to the memory system 410. As an example, a compression memory system 620b may be characterized as a plurality of logical memory devices, and lossy compression may be enabled or disabled on a per-logical-memory-device basis, as described herein.

As indicated above, FIG. 6 is provided as an example. Other examples may differ from what is described with regard to FIG. 6.

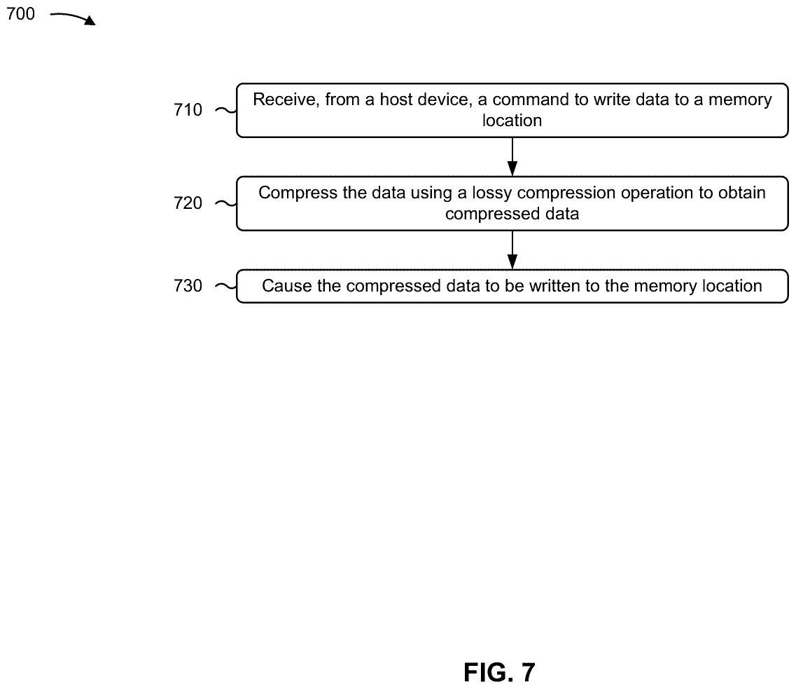

FIG. 7 is a flowchart of an example method 700 associated with lossy compression in memory. In some implementations, a controller (e.g., the controller 412) may perform or may be configured to perform the method 700. In some implementations, another device or a group of devices separate from or including the controller (e.g., the memory system 410) may perform or may be configured to perform the method 700. Additionally, or alternatively, one or more components of the controller (e.g., the lossy compression/decompression engine 416) may perform or may be configured to perform the method 700. Thus, means for performing the method 700 may include the controller and/or one or more components of the controller. Additionally, or alternatively, a non-transitory computer-readable medium may store one or more instructions that, when executed by the controller, cause the controller to perform the method 700.

As shown in FIG. 7, the method 700 may include receiving, from a host device, a command to write data to a memory location (block 710). As further shown in FIG. 7, the method 700 may include compressing the data using a lossy compression operation to obtain compressed data (block 720). As further shown in FIG. 7, the method 700 may include causing the compressed data to be written to the memory location (block 730).

The method 700 may include additional aspects, such as any single aspect or any combination of aspects described below and/or described in connection with one or more other methods or operations described elsewhere herein.

In a first aspect, a memory system includes one or more memory components configured as one or more logical memory devices.

In a second aspect, alone or in combination with the first aspect, the data is compressed and responsive to the memory location corresponding to a logical memory device, of the one or more logical memory devices, that is configured with lossy compression enabled.

In a third aspect, alone or in combination with one or more of the first and second aspects, the method 700 includes receiving an additional command to write additional data to an additional memory location, and causing the additional data to be written to the additional memory location without using the lossy compression operation, responsive to the additional memory location corresponding to an additional logical memory device, of the one or more logical memory devices, that is configured with lossy compression disabled.

In a fourth aspect, alone or in combination with one or more of the first through third aspects, the one or more logical memory devices include multiple logical memory devices mapped to multiple logical ports.

In a fifth aspect, alone or in combination with one or more of the first through fourth aspects, the method 700 includes receiving an additional command to read from the memory location, decompressing the compressed data using a decompression operation to obtain decompressed data, and outputting the decompressed data.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a memory system includes one or more memory components configurable as one or more logical memory devices, where the one or more logical memory devices are to be configured with lossy compression enabled or lossy compression disabled; and a controller configured to: receive, from a host device, a command to write data to a memory location; compress the data to obtain compressed data, responsive to the memory location corresponding to a logical memory device, of the one or more logical memory devices, that is configured with lossy compression enabled; and cause the compressed data to be written to the memory location.

In some implementations, a system includes one or more host devices; and a memory pool, including: a non-compression memory system; and a compression memory system, including: one or more memory components configurable as one or more logical memory devices, where the one or more logical memory devices are to be configured with lossy compression enabled or lossy compression disabled; and a controller configured to: receive, from a host device, a command to write data to a memory location; compress the data using a lossy compression operation to obtain compressed data, responsive to the memory location corresponding to a logical memory device, of the one or more logical memory devices, that is configured with lossy compression enabled; and write the compressed data to the memory location.

In some implementations, a method includes receiving, by a controller of a memory system, and from a host device, a command to write data to a memory location; compressing, by the controller, the data using a lossy compression operation to obtain compressed data; and causing, by the controller, the compressed data to be written to the memory location.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more memory components configurable as one or more logical memory devices,
wherein the one or more logical memory devices are to be configured with lossy compression enabled or lossy compression disabled; and
a controller configured to:
receive, from a host device, a command to write data to a memory location;
compress the data to obtain compressed data, responsive to the memory location corresponding to a logical memory device, of the one or more logical memory devices, that is configured with lossy compression enabled; and
cause the compressed data to be written to the memory location.

2. The memory system of claim 1, wherein the controller is configured to compress the data using the lossy compression operation using a lossy compression and decompression engine of the controller.

3. The memory system of claim 1, wherein the controller is further configured to:
receive an additional command to write additional data to an additional memory location; and
cause the additional data to be written to the additional memory location without using the lossy compression operation, responsive to the additional memory location corresponding to an additional logical memory device, of the one or more logical memory devices, that is configured with lossy compression disabled.

4. The memory system of claim 1, wherein the controller is further configured to:
receive an additional command to read from the memory location;
decompress the compressed data using a decompression operation to obtain decompressed data; and
output the decompressed data.

5. The memory system of claim 1, wherein the controller is further configured to:
determine an updated virtual memory capacity of the one or more logical memory devices resulting from the compressed data being written to the memory location; and
output an indication of the updated virtual memory capacity.

6. The memory system of claim 1, wherein the data is associated with a flag indicating that the data is approximable.

7. The memory system of claim 1, wherein the one or more memory components comprise volatile memory.

8. A system, comprising:
one or more host devices; and
a memory pool, comprising:
a non-compression memory system; and
a compression memory system, comprising:
one or more memory components configurable as one or more logical memory devices,
wherein the one or more logical memory devices are to be configured with lossy compression enabled or lossy compression disabled; and
a controller configured to:
receive, from a host device, a command to write data to a memory location;
compress the data using a lossy compression operation to obtain compressed data, responsive to the memory location corresponding to a logical memory device, of the one or more logical memory devices, that is configured with lossy compression enabled; and
write the compressed data to the memory location.

9. The system of claim 8, wherein the one or more logical memory devices comprise multiple logical memory devices.

10. The system of claim 8, wherein the controller is further configured to:
receive an additional command to write additional data to an additional memory location; and
cause the additional data to be written to the additional memory location without using the lossy compression operation, responsive to the additional memory location corresponding to an additional logical memory device, of the one or more logical memory devices, that is configured with lossy compression disabled.

11. The system of claim 8, wherein the controller is further configured to:
receive an additional command to read from the memory location;
decompress the compressed data using a decompression operation to obtain decompressed data; and
output the decompressed data.

12. The system of claim 8, wherein the controller is further configured to:
determine an error value for the compressed data,
wherein the controller is configured to cause the compressed data to be written to the memory location responsive to the error value satisfying a threshold.

13. The system of claim 12, wherein the controller, to determine the error value, is configured to:
decompress the compressed data to obtain decompressed data; and
compare the decompressed data to the data,
wherein the error value is in accordance with a difference between the decompressed data and the data.

14. The system of claim 8, wherein the compression memory system is a Type 3 Compute Express Link (CXL) device.

15. A method, comprising:
receiving, by a controller of a memory system, and from a host device, a command to write data to a memory location;
compressing, by the controller, the data using a lossy compression operation to obtain compressed data; and
causing, by the controller, the compressed data to be written to the memory location.

16. The method of claim 15, wherein the memory system comprises one or more memory components configured as one or more logical memory devices.

17. The method of claim 16, wherein the data is compressed and responsive to the memory location corresponding to a logical memory device, of the one or more logical memory devices, that is configured with lossy compression enabled.

18. The method of claim 16, further comprising:
receiving an additional command to write additional data to an additional memory location; and
causing the additional data to be written to the additional memory location without using the lossy compression operation, responsive to the additional memory location corresponding to an additional logical memory device, of the one or more logical memory devices, that is configured with lossy compression disabled.

19. The method of claim 16, wherein the one or more logical memory devices comprise multiple logical memory devices mapped to multiple logical ports.

20. The method of claim 15, further comprising:
receiving an additional command to read from the memory location;
decompressing the compressed data using a decompression operation to obtain decompressed data; and
outputting the decompressed data.
